(19) United States
(12) Patent Application Publication
(10) Pub. No.: US 2026/0152342 A1
(43) Pub. Date: Jun. 4, 2026

(54) Promotional Trash Bag and Can Liner

(71) Applicants: Ami Howsey, Rising Star, TX (US); Chris Ezra, Rising Star, TX (US)

(72) Inventors: Ami Howsey, Rising Star, TX (US); Chris Ezra, Rising Star, TX (US)

(21) Appl. No.: 19/409,091

(22) Filed: Dec. 4, 2025

Related U.S. Application Data
(60) Provisional application No. 63/728,058, filed on Dec. 4, 2024.

(51) Int. Cl. B65F 1/06

(52) U.S. Cl. CPC B65F 1/06

(57) ABSTRACT

The trash can bag and trash can liner covers the inside and outside of a trash receptacle. The promotional trash bag and can liner provide users with a device that presents a message along the outer surface once the upper section folds over the lower section. The promotional trash bag and can liner has a lower section that sits within and covers the inner portion of a trash receptacle, such as a trash barrel or trash can. Furthermore, the promotional trash bag and can liner has the upper section which folds over the sides of a trash receptacle covering the outer surface.

### FIELD OF THE INVENTION

The present invention relates generally to a promotional trash bag and trash can liner. More specifically, the present invention is a device that fits into a standard trash barrel and covers the outer surface of the trash barrel.

### BACKGROUND OF THE INVENTION

Trash can bags and liners are essential products used to line the interior of trash cans, providing a barrier that helps contain waste and makes disposal easier and more sanitary. These bags prevent waste from coming into direct contact with the can itself, reducing the buildup of odors, bacteria, and mess that would otherwise require frequent cleaning of the can. Trash bags and liners come in a range of sizes, colors, and thicknesses to accommodate different types of trash cans and waste disposal needs, from small bins in offices and bathrooms to large outdoor trash cans. They are often made from plastic materials such as high-density polyethylene (HDPE) or low-density polyethylene (LDPE), which vary in strength and durability.

Some trash can liners are designed to handle specific types of waste, such as biodegradable liners for composting, scented bags to mask odors, or heavy-duty liners for handling sharp or heavy objects. Many households and businesses rely on these liners for a convenient and hygienic way to manage waste. In addition, the availability of eco-friendly options, such as compostable and recycled plastic liners, is increasing as consumers and companies prioritize environmental sustainability. Trash can liners are an everyday item that greatly improves waste management efficiency, cleanliness, and convenience in various settings, including homes, offices, public spaces, and industrial facilities.

An objective of the present invention is to provide users with a trash bag and trash liner to help cover the outside and inside of a trash barrel. The present invention intends to provide users with a device that combines a trash bag and a trash liner. In order to accomplish that, a preferred embodiment of the present invention comprises an upper section 1 and a lower section 2. Thus, the present invention is a promotional trash bag and trash can liner that covers the entirety of the trash can while presenting a logo or message along the front side.

### BRIEF DESCRIPTION OF THE DRAWINGS

FIG. 1 is a top front right perspective view of the present invention.

FIG. 2 is a bottom rear left perspective view of the present invention.

FIG. 3 is a front view of the present invention.

FIG. 4 is a top view of the present invention.

FIG. 5 is a bottom view of the present invention.

FIG. 6 is a top front right perspective view of the present invention in a folded configuration.

FIG. 7 is a bottom rear left perspective view of the present invention in a folded configuration.

FIG. 8 is a front view of the present invention in a folded configuration.

FIG. 9 is a top view of the present invention in a folded configuration.

FIG. 10 is an exploded perspective view of the present invention in a folded configuration and a trash receptacle.

FIG. 11 is a cross-sectional view of the present invention in a folded configuration.

### DETAILED DESCRIPTION OF THE INVENTION

All illustrations of the drawings are for the purpose of describing selected versions of the present invention and are not intended to limit the scope of the present invention.

The present invention is a trash can bag and trash can liner that covers the inside and outside of a trash receptacle 4. The present invention seeks to provide users with a device that presents a message along the outer surface once the upper section 1 folds over the lower section 2. In order to accomplish this the present invention comprises a lower section 2 that sits within and covers the inner portion of a trash receptacle 4 such as a trash barrel or trash can. Further, the upper section 1 folds over the sides of a trash receptacle 4 covering the outer surface. The present invention is designed to be utilized at various types of events and location such as sports stadiums, hospitals, airports, government facilities, military facilities, and parks. Thus, the present invention is a promotional trash bag and trash can liner that covers the entirety of the trash can while presenting a logo or message along the front side.

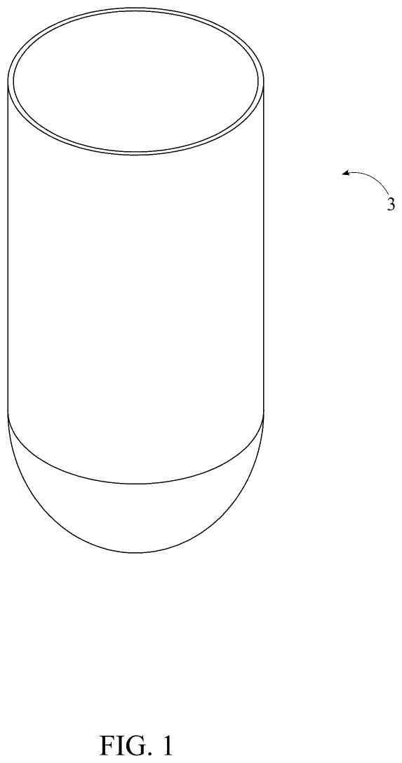

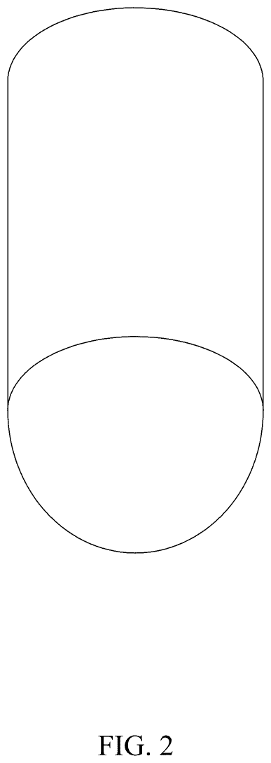

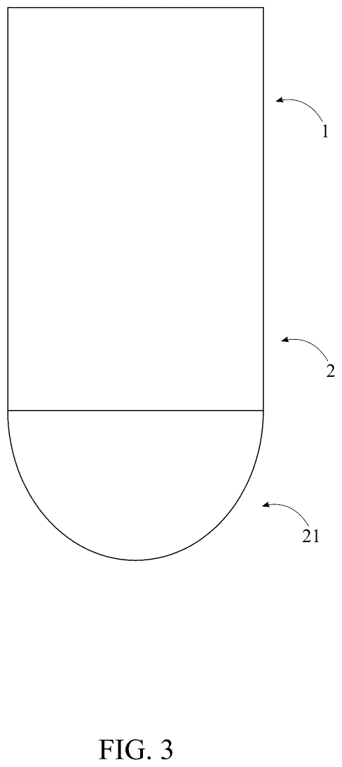

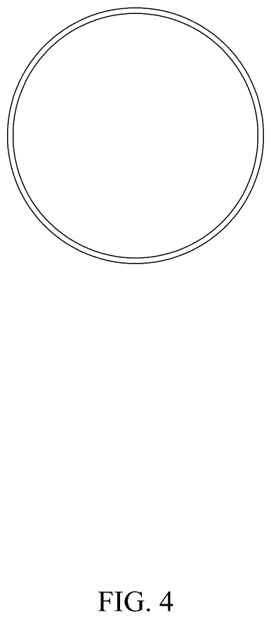

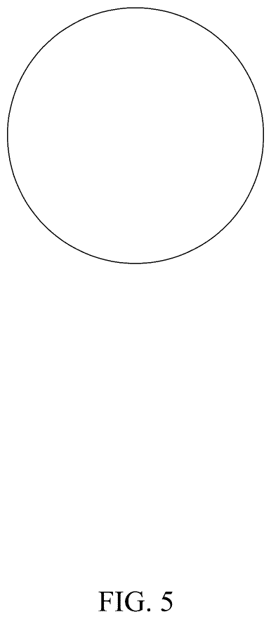

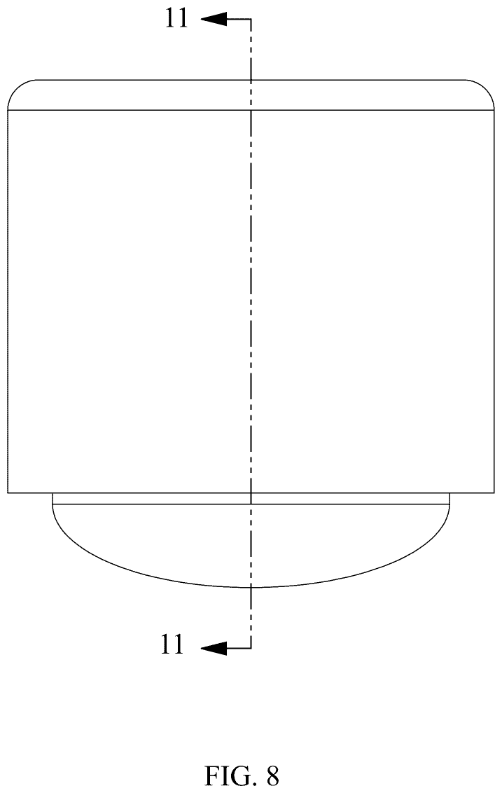

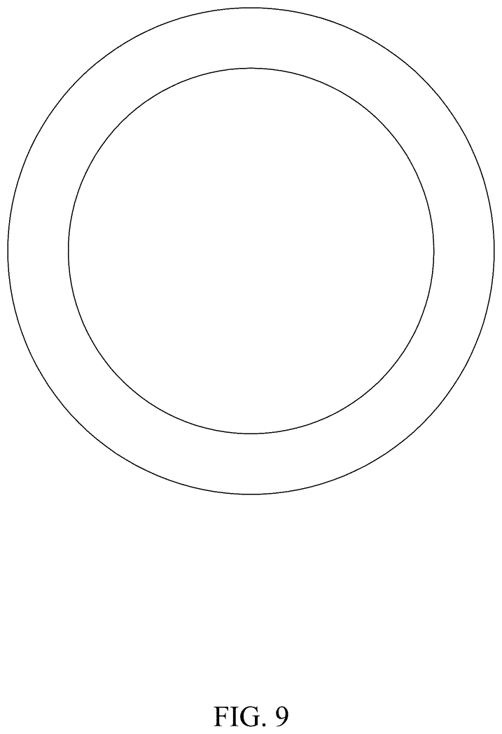

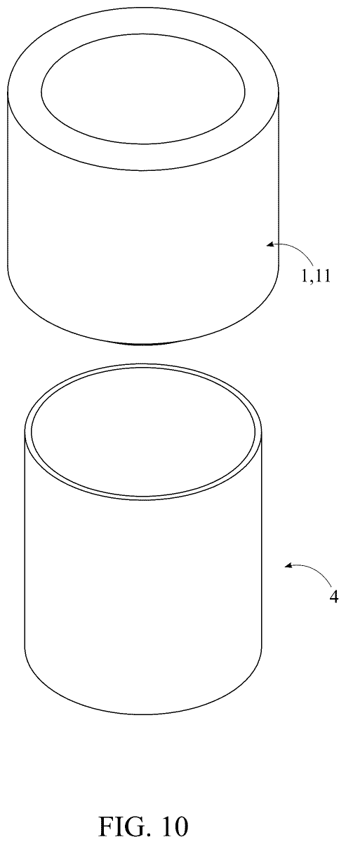

As shown in FIG. 1-11, the present invention is an extra-long trash bag 3 that enables a user to place the present invention within a trash receptacle 4 and fold the upper section 1 over the lower section 2 and trash receptacle 4. An objective of the present invention is to provide users with a device that provides messaging or a logo when folded over the trash can or barrel. To accomplish this the present invention comprises an upper section 1 and a lower section 2. The upper section 1 is bonded to the lower section 2 and extends upwards forming a singular long trash bag 3. Thus, the present invention is a promotional trash bag and trash can liner that covers the entirety of the trash receptacle 4 while presenting a logo or message along the front side.

The present invention is designed with a heavy-duty liner material that is non-porous to prevent spilled or thrown away items and liquids to seep through and reach the trash receptacle 4 where as shown in FIG. 1. The present invention may come in various colors and sizes to accommodate various sized trash receptacles 4 while providing a different color look. In its preferred embodiment the lower section 2 is designed with the same material as the present invention and provides a bag base 21 that reaches the bottom and entirely lines a trash can or trash barrel. The lower section 2 is designed with a cylindrical shape and a curved base. The lower section 2 receives trash thrown into the trash receptacle 4. The lower section 2 comprises a bag base 21 and an inner surface 22. It should be further noted that, the lower section 2 can be created in various shapes and sizes while still staying within the scope of the present invention. In an alternative embodiment the lower section 2 is designed with an eco-friendly material and a seam along the top side to enable the upper section 1 to either easily fold or easily detach.

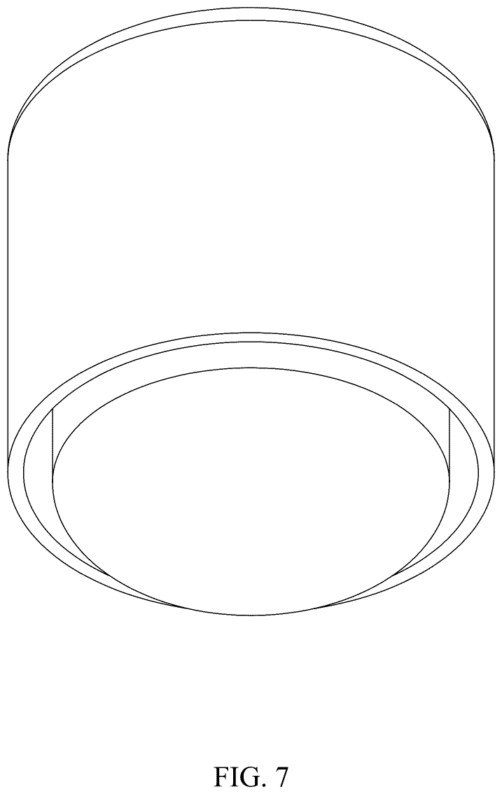

The upper section 1 extends from the top side of the lower section 2. The upper section 1 is designed with a similar material as the lower section 2 with a flexible material that may fold over the lower section 2 or trash can or trash barrel. In its preferred embodiment the upper section 1 comprising a text surface 11, a text print 12, and a connection section 13. The text is positioned along the inner surface 22 of the upper section 1. The text is designed to be positioned along the outer surface of the present invention as the upper section 1 folds over the lower section 2 as shown in FIG. 7. The upper section 1 prevents the overflow or trash and prevents the present invention from sliding into the trash can. Furthermore, the upper section 1 protects the outside of the trashcan from getting dirty from trash thrown into the trash receptacle 4. The upper section 1 bonds to the lower section 2. The upper section 1 and the lower section 2 forms one long trash bag 3. The long trash bag 3 covers a trash receptacle 4. The connection section 13 is positioned between the upper section 1 and the lower section 2. The connection section 13 bonds the upper section 1 and the lower section 2 together. The upper section 1 folds to wrap around a trash receptacle 4. The text print 12 may display a logo, image or messaging as desired by the user. The logo can be positioned anywhere on the upper section 1 of the promotional trash bag and trash can liner as seen from the outside. For example the logo may wrap completely around the exterior of the upper section 1. This design enables the present invention to be utilized at various events showcasing a sporting team logo or mascot along the upper section 1, directions, information, and various other text. In an alternative embodiment the upper section 1 may utilize drawstring 14s to cinch the upper section 1 around a trash receptacle 4.

The text surface 11 is positioned along the outer side of the upper section 1 when the upper section 1 is folded over the trash receptacle 4. This enables the text surface 11 to be seen from the outside when on a trash receptacle 4. The text print 12 is positioned along the front of the text surface 11. As a result, the text print 12 is easily readable. In an alternative embodiment the text print 12 is positioned along each side of the text surface 11. Consequently, this enables the text print 12 to be ready from various sides of the present invention.

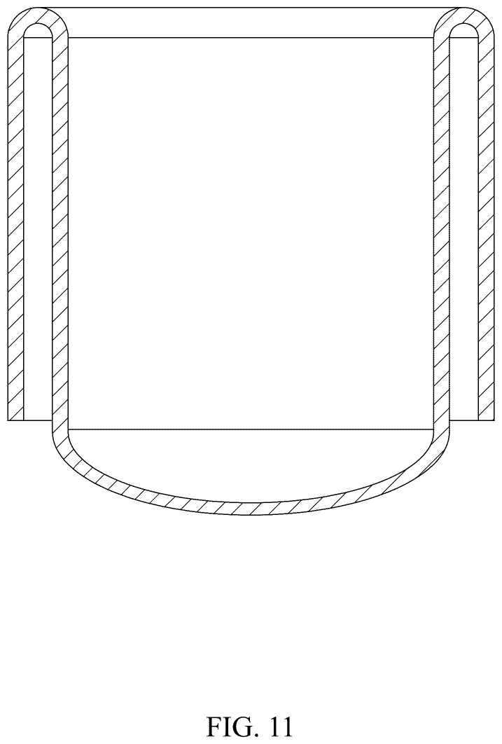

In reference to FIG. 11, the connection section 13 bends to enable the upper section 1 to wrap around a trash receptacle 4 while the lower section 2 is within the trash receptacle 4. Accordingly, the long trash bag 3 may wrap around various sized and shaped trash receptacles 4. The bag base 21 is positioned along the bottom of the lower section 2. The bag base 21 functions as the bottom of a trash bag. The bag base 21 covers the bottom of the trash receptacle 4. Thus, the bag base 21 prevents trash from touching and dirtying the trash receptacle 4.

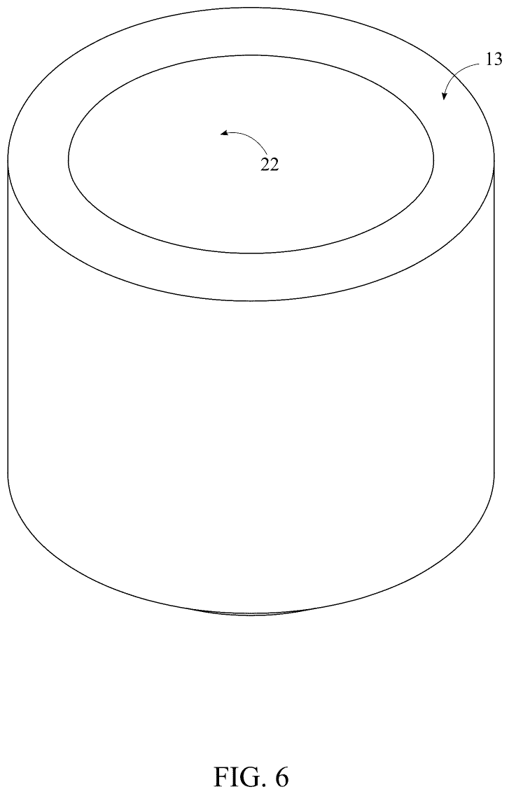

The inner surface 22 is positioned along the inner side of the lower section 2 as seen in FIG. 6. The inner surface 22 protects the sides of the trash receptacle 4 from getting dirty. The upper section 1 further comprises a drawstring 14. The drawstring 14 is integrated into the upper section 1 adjacent to the connection section 13. So, the drawstring 14 enables the long trash bag 3 to be cinched or tightened around a trash receptacle 4 to conform to various sized openings. Furthermore, the drawstring 14 enables the long trash bag 3 to be tied shut to hold any trash stored within. With all the components working in tandem with each other it can be seen that, the present invention is a promotional trash bag and trash can liner that covers the entirety of the trash can while presenting a logo or message along the front side.

Although the invention has been explained in relation to its preferred embodiment, it is to be understood that many other possible modifications and variations can be made without departing from the spirit and scope of the invention as hereinafter claimed.

What is claimed is:

1. A promotional trash bag and can liner comprising:
an upper section;
a lower section;
the upper section comprising a text surface, a text print, and a connecting section;
the lower section comprising a bag base and an inner surface;
the upper section bonding to the lower section;
the upper section and the lower section forming one long trash bag;
the long trash bag covering a trash receptacle;
the connecting section being positioned between the upper section and the lower section;
the connecting section bonding the upper section and the lower section together; and
the upper section folding to wrap around a trash receptacle.

2. The promotional trash bag and can liner as claimed in claim 1 comprising:
the text surface being positioned along the outer side of the upper section when the upper section is folded over the trash receptacle; and
the text print being positioned along the front of the text surface.

3. The promotional trash bag and can liner as claimed in claim 2 wherein the text print being positioned along each side of the text surface.

4. The promotional trash bag and can liner as claimed in claim 1 wherein the connecting section bending to enable the upper section to wrap around a trash receptacle while the lower section is within the trash receptacle.

5. The promotional trash bag and can liner as claimed in claim 1 comprising:
the bag base being positioned along the bottom of the lower section; and
the bag base covering the bottom of the trash receptacle.

6. The promotional trash bag and can liner as claimed in claim 1 wherein the inner surface being positioned along the inner side of the lower section.

7. The promotional trash bag and can liner as claimed in claim 2 comprising:
the upper section further comprising a drawstring; and
the drawstring being integrated into the upper section adjacent to the connecting section.

8. A promotional trash bag and can liner comprising:
an upper section;
a lower section;
the upper section comprising a text surface, a text print, and a connecting section;
the lower section comprising a bag base and an inner surface;
the upper section bonding to the lower section;
the upper section and the lower section forming one long trash bag;
the long trash bag covering a trash receptacle;
the connecting section being positioned between the upper section and the lower section;
the connecting section bonding the upper section and the lower section together;
the upper section folding to wrap around a trash receptacle;
the text surface being positioned along the outer side of the upper section when the upper section is folded over the trash receptacle; and
the text print being positioned along the front of the text surface.

9. The promotional trash bag and can liner as claimed in claim 8 wherein the text print being positioned along each side of the text surface.

10. The promotional trash bag and can liner as claimed in claim 8 wherein the connecting section bending to enable the upper section to wrap around a trash receptacle while the lower section is within the trash receptacle.

11. The promotional trash bag and can liner as claimed in claim 8 comprising:
the bag base being positioned along the bottom of the lower section; and
the bag base covering the bottom of the trash receptacle.

12. The promotional trash bag and can liner as claimed in claim 8 wherein the inner surface being positioned along the inner side of the lower section.

13. The promotional trash bag and can liner as claimed in claim 8 comprising:
the upper section further comprising a drawstring; and
the drawstring being integrated into the upper section adjacent to the connecting section.

14. A promotional trash bag and can liner comprising:
an upper section;
a lower section;
the upper section comprising a text surface, a text print, and a connecting section;
the lower section comprising a bag base and an inner surface;
the upper section bonding to the lower section;
the upper section and the lower section forming one long trash bag;
the long trash bag covering a trash receptacle;
the connecting section being positioned between the upper section and the lower section;
the connecting section bonding the upper section and the lower section together;
the upper section folding to wrap around a trash receptacle;
the text surface being positioned along the outer side of the upper section when the upper section is folded over the trash receptacle;
the text print being positioned along the front of the text surface;
the bag base being positioned along the bottom of the lower section; and
the upper section further comprising a drawstring.

15. The promotional trash bag and can liner as claimed in claim 14 wherein the text print being positioned along each side of the text surface.

16. The promotional trash bag and can liner as claimed in claim 14 wherein the connecting section bending to enable the upper section to wrap around a trash receptacle while the lower section is within the trash receptacle.

17. The promotional trash bag and can liner as claimed in claim 14 wherein the bag base covering the bottom of the trash receptacle.

18. The promotional trash bag and can liner as claimed in claim 14 wherein the inner surface being positioned along the inner side of the lower section.

19. The promotional trash bag and can liner as claimed in claim 14 wherein the drawstring being integrated into the upper section adjacent to the connecting section.
